(19) United States
(12) Patent Application Publication
(10) Pub. No.: US 2008/0246432 A1
(43) Pub. Date: Oct. 9, 2008

(54) FUEL CELL POWER SUPPLY SYSTEM INTEGRATED WITH RECHARGEABLE BATTERIES

(75) Inventors: Ming-Yao Dong, Chupei (TW); Chun-Chin Tung, Chupei (TW)

Correspondence Address: G. LINK CO., LTD., 3550 BELL ROAD, MINOOKA, IL, 60447, US

(73) Assignees: SYSPOTEK CORPORATION, CHUPEI (TW); ANTIG TECHNOLOGY CORPORATION, GEORGE TOWN, KY (US)

(21) Appl. No.: 12/059,159

(22) Filed: Mar. 31, 2008

(30) Foreign Application Priority Data
Apr. 3, 2007 (TW) 096111787

(51) Int. Cl. H02J 7/00

(52) U.S. Cl. 320/101

(57) ABSTRACT

A fuel cell power supply system integrated with rechargeable batteries comprises a fuel cell unit, a rechargeable battery device and a loop switching device. The fuel cell unit outputs DC power; the rechargeable battery device comprises a plurality of rechargeable batteries which are secondary cells and able to output or input DC power; and the loop switching device comprises a DC power output terminal and an electrical connect/disconnect selection means. The fuel cell unit and the rechargeable batteries are respectively electrically connected to the loop switching device, and the loop switching device selects electrical contact between the fuel cell unit and any rechargeable battery in the rechargeable battery device, and selects electrical connection between any other rechargeable battery in the rechargeable battery device and DC power output terminal of the loop switching device.

### FIELD OF THE INVENTION

The present invention relates to a fuel cell power supply system integrated with rechargeable batteries, more particularly a power supply system that can charge the rechargeable battery with a fuel cell unit and output the power needed directly via the rechargeable battery.

### BACKGROUND OF THE INVENTION

Conventional fuel cells use hydrogen-rich fuel (e.g. methanol) and oxygen fuel to undergo electrochemical reaction and supply electric power. This type of fuel cell must have a sophisticated balance of plant (BOP) system to control the operating conditions for the electrochemical reaction and for process control. Moreover, when the fuel cell is used in a situation where the load change is more drastic, a sophisticated power management system in addition to the BOP system for operating condition control is needed to support the secondary cells in power allocation.

Thus conventional fuel cell power supply systems integrated with secondary cells not only pose control challenge. The requirement for a sophisticated BOP system or power management system could also jack up the cost of the power supply system.

In light of the drawbacks of conventional fuel cells, the inventor aims to develop fuel cell power supply system integrated with rechargeable batteries.

### SUMMARY OF THE INVENTION

The primary object of the invention is to provide a fuel cell power supply system integrated with rechargeable batteries that uses power generated by a fuel cell unit to charge the rechargeable battery and outputs power needed directly via the rechargeable battery, thereby simplifying the control of core reaction conditions of the fuel cell unit, and furthermore, simplifying the apparatus or control process needed for controlling the reaction conditions of the fuel cell-based power supply system.

Another object of the invention is to provide a fuel cell supply system integrated with rechargeable batteries that can switch the charge state or power output state among a plurality of rechargeable batteries to achieve a power supply system that use fuel cells for power generation and rechargeable batteries for power output.

Yet another object of the invention is to provide a fuel cell power supply system integrated with rechargeable batteries that uses an electrical loop and voltage drop or voltage rise occurred during charge state or power output state of rechargeable batteries to achieve the switching of charge state or power output state among a plurality of rechargeable batteries.

To achieve the aforesaid objects, the present invention provides a fuel cell power supply system integrated with rechargeable batteries. The fuel cell power supply system comprises a fuel cell unit, a rechargeable battery device and a loop switching device. The fuel cell unit outputs DC power; the rechargeable battery device comprises a plurality of rechargeable batteries, the rechargeable batteries being secondary cells and able to output or input DC power; and the loop switching device comprises a DC power output terminal and an electrical connect/disconnect selection means. The fuel cell unit and the rechargeable batteries are respectively electrically connected to the loop switching device. The loop switching device selects electrical contact between the fuel cell unit and any rechargeable battery in the rechargeable battery device, and selects electrical connection between any other rechargeable battery in the rechargeable battery device and DC power output terminal of the loop switching device.

The loop switching device comprises a direction-limiting loop, the direction-limiting loop consisting of a first direction-limiting element, a second direction-limiting element, a third direction-limiting element and a fourth direction-limiting element, the direction-limiting elements respectively limiting the direction of current flow to forward direction. The first direction-limiting element is electrically connected to the second direction-limiting element in series. The third direction-limiting element is electrically connected to the fourth direction-limiting element in series. One end of the first direction-limiting element is defined as a first node, while the junction between the first direction-limiting element and the second direction-limiting element is defined as a second node, and the other end of the second direction-limiting element is defined as a third node. One end of the third direction-limiting element is electrically connected to the first node. The junction between the third direction-limiting element and the fourth direction-limiting element is defined as a fourth node, while the other end of the fourth direction-limiting element is electrically connected to the third node. Current passing from first node to second node, from second node to third node, from first node to fourth node, and from fourth node to third node flows uniformly in forward direction or counter direction. The DC power output terminal of the fuel cell unit, the DC power output terminal of the second rechargeable battery, the DC power output terminal of the loop switching device, and the DC power output terminal of the first rechargeable battery are respectively electrically connected to the first node, the second node, the third node and the fourth node.

The loop switching device further comprises a switch unit and a control unit. The switch unit is a logic control circuit. The control unit provides a microprocessor for logic control and controls the switch unit in the selection of electrical contact between the fuel cell unit and any of rechargeable batteries in the rechargeable battery device and the selection of any other rechargeable battery in the rechargeable battery device for power output.

The loop switching device further comprises a sensor unit. The sensor unit is a power detection element and electrically connected to the first rechargeable battery and the second rechargeable battery in the rechargeable battery device respectively. The sensor unit feeds the characteristics of power respectively output by the first rechargeable battery and the second rechargeable battery to the control unit. The control unit then determines the operational process of the switch unit based on such power characteristics.

Thus the benefits of the present invention include: simplifying the control of core reaction conditions of the fuel cell unit, and furthermore, simplifying the apparatus or control process needed for controlling the reaction conditions of the fuel cell-based power supply system; enabling the switching of charge state or power output state among a plurality of rechargeable batteries to achieve a power supply system that use fuel cells for power generation and rechargeable batteries for power output; and using an electrical loop and voltage drop or voltage rise occurred during charge state or power output state of rechargeable batteries to achieve the switching of charge state or power output state among a plurality of rechargeable batteries.

The objects, features and effects of the invention are described in detail below with embodiments in reference to the accompanying drawings.

### BRIEF DESCRIPTION OF THE DRAWINGS

FIG. 1 is the component diagram of a fuel cell power supply system integrated with rechargeable batteries according to an embodiment of the invention;

FIG. 2 is the component diagram of a fuel cell power supply system integrated with rechargeable batteries according to another embodiment of the invention;

FIG. 3 is the component diagram of a fuel cell power supply system integrated with rechargeable batteries according to a third embodiment of the invention; and

FIG. 4 is the component diagram of a fuel cell power supply system integrated with rechargeable batteries according to a fourth embodiment of the invention.

### DETAILED DESCRIPTION OF THE INVENTION

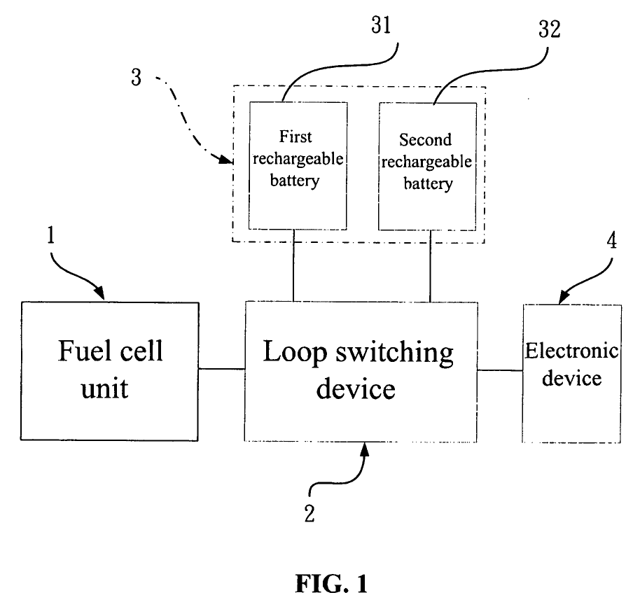

FIG. 1 is the component diagram of a fuel cell power supply system integrated with rechargeable batteries according to an embodiment of the invention. As shown, the fuel cell power supply system integrated with rechargeable batteries comprises a fuel cell unit (1), a loop switching device (2) and a rechargeable battery device (3). The fuel cell unit (1) contains the fuel cell core for power generation, hence able to undergo fuel cell operation, generate DC power and output power from the positive and negative DC voltage terminals. The rechargeable battery device (3) contains a plurality of rechargeable batteries and recharge circuits, each rechargeable battery being electrically connected to the loop switch device (2) and able to generate DC power and output the power via its positive DC voltage terminal and negative DC voltage terminal to the loop switching device (2). The loop switching device (2) selects the rechargeable battery in the rechargeable battery device (3) for power supply or the fuel cell unit (1) charges the rechargeable battery in the rechargeable battery device (3) via the recharge circuit. The loop switching device (2) contains a circuit means at the DC power output terminal to form a DC power loop. The loop switching device (2) is able to select electrical contact between the fuel cell unit (1) and any rechargeable battery in the rechargeable battery device (3), and at the same time select any other rechargeable battery in the rechargeable battery device (3) to output power or become electrically connected to an electronic device (4). Hence while some rechargeable batteries in the rechargeable battery device (3) are outputting power, the fuel cell unit (1) can charge other rechargeable batteries not outputting power.

Specifically, the fuel cell unit (1) can output power of specific voltage. The rechargeable battery device (3) comprises a first rechargeable battery (31) and a second rechargeable battery (32). The loop switching device (2) can choose the fuel cell unit (1) to be electrically connected to the first rechargeable battery (31) and the second rechargeable battery (32) to be electrically connected to the electronic device (4), or the loop switching device (2) can choose the fuel cell unit (1) to be electrically connected to the second rechargeable battery (32) and the first rechargeable battery (31) to be electrically connected to the electronic device (4). Thus when the power in the rechargeable battery (31) is down, the loop switching device (2) can choose the fuel cell unit (1) to become electrically connected to the first rechargeable battery (31) and the second rechargeable battery (32) to become electrically connected to the electronic device (4) such that the fuel cell unit (1) can charge the first rechargeable battery (31) and the second rechargeable battery (32) can output power to the electronic device (4). Similarly, when the power in the second rechargeable battery (32) is down, the loop switching device (2) can choose the fuel cell unit (1) to become electrically connected to the second rechargeable battery (32) and the first rechargeable battery (31) to become electrically connected to the electronic device (4) such that the fuel cell unit (1) can charge the second rechargeable battery (32) and the first rechargeable battery (31) can output power to the electronic device (4).

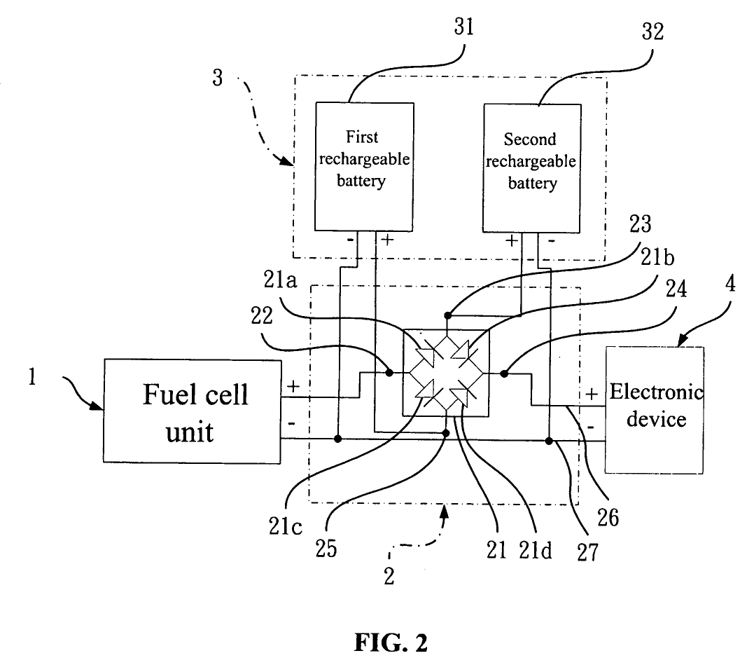

FIG. 2 is the component diagram of a fuel cell power supply system integrated with rechargeable batteries according to another embodiment of the invention. As shown, the loop switching device (2) in the fuel cell power system consists of a direction-limiting loop (21), a first DC power output terminal (26) and a second DC power output terminal (27). The direction-limiting loop (21) contains a first direction-limiting element (21a), a second direction-limiting element (21b), a third direction-limiting element (21c) and a fourth direction-limiting element (21d). The direction-limiting elements are used to confine the current flow to forward direction. More specifically, the direction-limiting elements are respectively a diode. The loop switching device (2) further consists of a first node (22), a second node (23), a third node (24), and a fourth node (25). The direction-limiting loop (21) is electrically connected to the fuel cell unit (1), the second rechargeable battery (32), the first DC power output terminal (26), and the first rechargeable battery (31) via the first node (22), the second node (23), the third node (24), and the fourth node (25) respectively. The first direction-limiting element (21a) is electrically connected to the second direction-limiting element (21b) in series. The third direction-limiting element (21c) is electrically connected to the fourth direction-limiting element (21d) in series. One end of the first direction-limiting element (21a) is electrically connected to the first node (22). The other end of the first direction-limiting element (21a) and one end of the second direction-limiting element (21b) are electrically connected to the second node (23). The other end of the second direction-limiting element (21b) is electrically connected to the third node (24). One end of the third direction-limiting element (21c) is electrically connected to the first node (22). The other end of the third direction-limiting element (21c) and one end of the fourth direction-limiting element (21d) are electrically connected to the fourth node (25). The other end of the fourth direction-limiting element (21d) is electrically connected to the third node (24). As such, the electrically serially connected first direction-limiting element (21a) and second direction-limiting element (21b) are in parallel connection with the electrically serially connected third direction-limiting element (21c) and fourth direction-limiting element (21d), and the current passing from first node (22) to second node (23), from second node (23) to third node (24), from first node (22) to fourth node (25), and from fourth node (25) to third node (24) flows uniformly in forward direction. Moreover, the positive DC voltage terminal of the fuel cell unit (1), the positive DC voltage terminal of the second rechargeable battery (32), the first DC power output terminal (26) of the loop switching device (2), and the positive DC voltage terminal of the first rechargeable battery (31) are respectively electrically connected to the first node (22), the second node (23), the third node (24) and the fourth node (25), while the negative DC voltage terminal of the fuel cell unit (1), the negative DC voltage terminal of the first rechargeable battery (31) and the negative DC voltage terminal of the second rechargeable battery (32) are respectively electrically connected to the second DC power output terminal (27).

Moreover, the first DC power output terminal (26) and the second DC power output terminal (27) of the loop switching device (2) can be respectively the anode channel and cathode channel for DC power, while the fuel cell unit (1), the rechargeable battery device (3) and the electronic device (4) achieve circuit grounding via the second DC power output terminal (27).

Thus after power is output to the electronic device (4) from the positive DC voltage terminal of the second rechargeable battery (32) through in sequence the second node (23), the second direction-limiting element (21b), the third node (24), and the first DC power output terminal (26) of the direction-limiting loop (21), the output voltage of the second rechargeable battery (32) would drop gradually to a level lower than the output voltage of first rechargeable battery (31) and lower than the output voltage of the fuel cell unit (1). Subsequently, the fuel cell unit (1) would output power and charge the second rechargeable battery (32) from its positive DC voltage terminal through in sequence the first node (22), the first direction-limiting element (21a) and the second node (23). At the same time, the first rechargeable battery (31) outputs power to the electronic device (4) from its positive DC voltage terminal and through in sequence the fourth node (25), the fourth direction-limiting element (21d), the third node (24), and the first DC power output terminal (26) of the direction-limiting loop (21). The output voltage of the first rechargeable battery (31) would drop gradually to a level lower than the output voltage of second rechargeable battery (32) and lower than the output voltage of the fuel cell unit (1). As such, the first rechargeable battery (31) and the second rechargeable battery (32) of the rechargeable battery device (3) form an alternating charge and discharge mechanism.

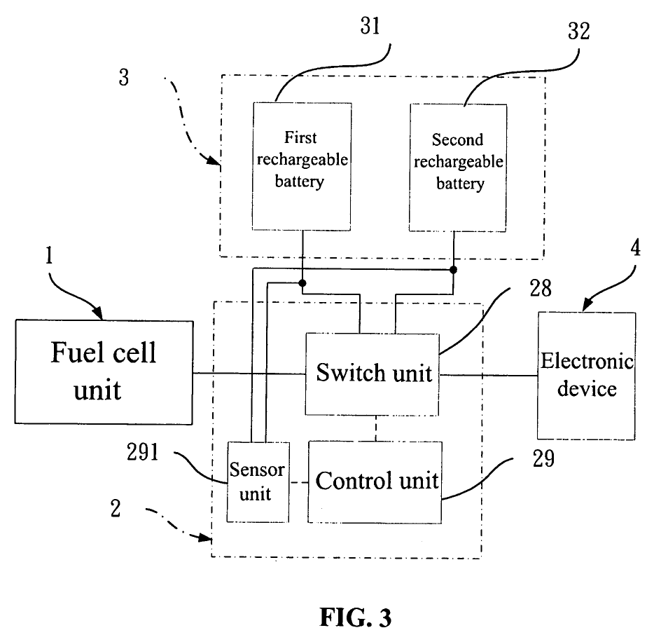

FIG. 3 is the component diagram of a fuel cell power supply system integrated with rechargeable batteries according to a third embodiment of the invention. As shown, the loop switching device (2) in the fuel cell power system consists of a switch unit (28) and a control unit (29). The switch unit (28) is a logic control circuit. The control unit (29) provides a microprocessor for logic control and controls the switch unit (28) in the selection of electrical contact between the fuel cell unit (1) and any of rechargeable batteries in the rechargeable battery device (3) and the selection of any other rechargeable battery in the rechargeable battery device (3) for power output or for electrical contact with an electronic device (4).

As such, when the voltage of the second rechargeable battery (32) in the fuel cell power supply system of the invention is higher than that of the first rechargeable battery (31), the control unit (29) could control the switch unit (28) to enable the fuel cell unit (1) to become electrically connected to the first rechargeable battery (31) and the second rechargeable battery (32) to become electrically connected to the electronic device (4) such that the fuel cell unit (1) could charge the first rechargeable battery (31) and the second rechargeable battery (32) could output power to the electronic device (4). Similarly, the control unit (29) could control the switch unit (28) to enable the fuel cell unit (1) to become electrically connected to the second rechargeable battery (32) and the first rechargeable battery (31) to become electrically connected to the electronic device (4) such that the fuel cell unit (1) could charge the second rechargeable battery (32) and the first rechargeable battery (31) could output power to the electronic device (4).

The loop switching device (2) further comprises a sensor unit (291). The sensor unit (291) is a power detection element and electrically connected to the first rechargeable battery (31) and the second rechargeable battery (32) in the rechargeable battery device (3) respectively to detect the characteristics of power output by the first rechargeable battery (31) and the second rechargeable battery (32). The control unit (29) then determines the operational process of the switch unit (28) based on such information. Specifically, the sensor unit (291) could detect the voltage output by the first rechargeable battery (31) and the second rechargeable battery (32) respectively such that the control unit (29) could control the circuit logics of switch unit (28) based on the voltage signal fed back by the sensor unit (291). As such, when the voltage output by the first rechargeable battery (31) as fed back by the sensor unit (291) falls below a preset level, the control unit (29) would control the switch unit (28) to enable the fuel cell unit (1) to become electrically connected to the first rechargeable battery (31) and the second rechargeable battery (32) to become electrically connected to the electronic device (4) such that the fuel cell unit (1) could charge the first rechargeable battery (31) and the second rechargeable battery (32) could output power to the electronic device (4). Similarly, when the voltage output by the second rechargeable battery (32) as fed back by the sensor unit (291) falls below a preset level, the control unit (29) could control the switch unit (28) to enable the fuel cell unit (1) to become electrically connected to the second rechargeable battery (32) and the first rechargeable battery (31) to become electrically connected to the electronic device (4) such that the fuel cell unit (1) could charge the second rechargeable battery (32) and the first rechargeable battery (31) could output power to the electronic device (4).

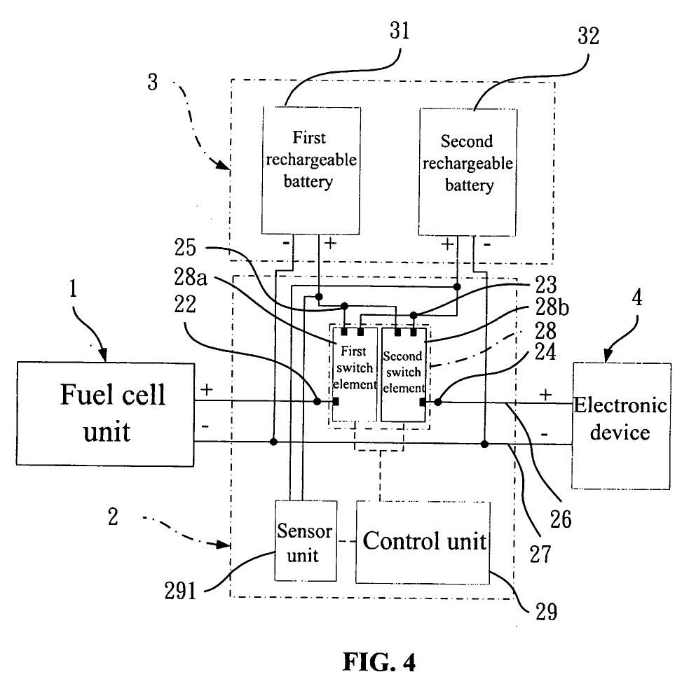

FIG. 4 is the component diagram of a fuel cell power supply system integrated with rechargeable batteries according to a fourth embodiment of the invention. As shown, the switch unit (28) in the loop switching device (2) is a logic control circuit comprising a first switch element (28a) and a second switch element (28b), the first switch element (28a) and the second switch element (28b) being respectively a one-to-multi port logic control gate element. The first switch element (28a) has an input terminal being electrically connected to the first node (22) and two output terminals being electrically connected to the second node (23) and the fourth node (25) respectively. The second switch element (28b) has two input terminals being electrically connected to the second node (23) and the fourth node (25) respectively and an output terminal being electrically connected to the third node (24) such that the first switch element (28a) is electrically connected to the fuel cell unit (1), the first rechargeable battery (31) and the second rechargeable battery (32), and the second switch element (28b) is electrically connected to the electronic device (4), the first rechargeable battery (31) and the second rechargeable battery (32). The control unit (29) controls the first switch element (28a) to enable electrical contact between the fuel cell unit (1) and the first rechargeable battery (31) and controls the second switch element (28b) to enable electrical contact between the second rechargeable battery (32) and the electronic device (4), or the control unit (29) controls the first switch element (28a) to enable electrical contact between the fuel cell unit (1) and the second rechargeable battery (32) and controls the second switch element (28b) to enable electrical contact between the first rechargeable battery (31) and the electronic device (4).

Moreover, the same as that in the aforementioned embodiment, the first DC power output terminal (26) and the second DC power output terminal (27) of the loop switching device (2) can be respectively the anode channel and cathode channel for DC power, while the fuel cell unit (1), the rechargeable battery device (3) and the electronic device (4) achieve circuit grounding via the second DC power output terminal (27).

Thus in the fuel cell power supply system integrated with rechargeable batteries of the invention, the voltage of the second rechargeable battery (32) can be preset higher than that of the first rechargeable battery (31). As such, when the voltage output by the first rechargeable battery (31) as fed back by the sensor unit (291) falls below a preset level, the control unit (29) would control the first switch element (28a) to enable electrical contact between the fuel cell unit (1) and the first rechargeable battery (31) and controls the second switch element (28b) to enable electrical contact between the second rechargeable battery (32) and the electronic device (4) such that the fuel cell unit (1) could charge the first rechargeable battery (31) and the second rechargeable battery (32) could output power to the electronic device (4). Similarly, when the voltage output by the second rechargeable battery (32) as fed back by the sensor unit (291) falls below a preset level, the control unit (29) could control the first switch element (28a) to enable electrical contact between the fuel cell unit (1) and the second rechargeable battery (32) and control the second switch element (28b) to enable electrical contact between the first rechargeable battery (31) and the electronic device (4) such that the fuel cell unit (1) could charge the second rechargeable battery (32) and the first rechargeable battery (31) could output power to the electronic device (4).

When the voltage output by both the first rechargeable battery (31) and the second rechargeable battery (32) as fed back by the sensor unit (291) falls below a preset level, the control unit (29) could control the first switch element (28a) to enable electrical contact between the fuel cell unit (1) and the first rechargeable battery (31) and control the second switch element (28b) to enable electrical disconnection between the second rechargeable battery (32) and the electronic device (4) such that the fuel cell unit (1) could charge the first rechargeable battery (31) while the second rechargeable battery (32) stops outputting power. Moreover, while the first rechargeable battery (31) is being charged and its voltage as fed back by the sensor unit (291) rises above a preset level, the control unit (29) could control the first switch element (28a) to enable electrical contact between the fuel cell unit (1) and the second rechargeable battery (32) and control the second switch element (28b) to enable electrical contact between the first rechargeable battery (31) and the electronic device (4) such that the fuel cell unit (1) could charge the second rechargeable battery (32) and the first rechargeable battery (31) to output power to the electronic device (4).

The examples cited above are meant to explain the invention and should not be construed as a limitation on the actual applicable scope of the invention, and as such, all modifications and alterations without departing from the spirits of the invention and appended claims shall remain within the protected scope and claims of the invention.

What is claimed is:

1. A fuel cell power supply system integrated with rechargeable batteries, comprising:
a fuel cell unit including a DC power output terminal for outputting DC power of constant voltage;
a rechargeable battery device consisting of a plurality of rechargeable batteries, the rechargeable batteries being secondary cells and including a DC power output terminal for the output or input of DC power; and
a loop switching device comprising a DC power output terminal and an electrical connect/disconnect selection means;
wherein the fuel cell unit and the rechargeable batteries are respectively electrically connected to the loop switching device, and the loop switching device selects electrical contact between the fuel cell unit and any rechargeable battery in the rechargeable battery device, and selects electrical connection between any other rechargeable battery in the rechargeable battery device and DC power output terminal of the loop switching device.

2. The fuel cell power supply system according to claim 1, wherein the plurality of rechargeable batteries in the rechargeable battery device include a first rechargeable battery and a second rechargeable battery;
wherein the loop switching device selects electrical contact between the fuel cell unit and the first rechargeable battery and selects electrical contact between the second rechargeable battery and the DC power output terminal of the loop switching device, or the loop switching device selects electrical contact between the fuel cell unit and the second rechargeable battery and selects electrical contact between the first rechargeable battery and the DC power output terminal of the loop switching device.

3. The fuel cell power supply system according to claim 2, wherein the loop switching device further comprises a direction-limiting loop, the direction-limiting loop containing a first direction-limiting element, a second direction-limiting element, a third direction-limiting element, and a fourth direction-limiting element, said direction-limiting elements respectively limiting the direction of current flow to forward direction;
wherein the first direction-limiting element is electrically connected to the second direction-limiting element in series, the third direction-limiting element is electrically connected to the fourth direction-limiting element in series, one end of the first direction-limiting element is defined as a first node, the junction between the first direction-limiting element and the second direction-limiting element is defined as a second node, the other end of the second direction-limiting element is defined as a third node, one end of the third direction-limiting element is electrically connected to the first node, the junction between the third direction-limiting element and the fourth direction-limiting element is defined as a fourth node, the other end of the fourth direction-limiting element is electrically connected to the third node, current passing from first node to second node, from second node to third node, from first node to fourth node, and from fourth node to third node flows uniformly in forward direction or counter direction; the DC power output terminal of the fuel cell unit, the DC power output terminal of the second rechargeable battery, the DC power output terminal of the loop switching device, and the DC power output terminal of the first rechargeable battery being respectively electrically connected to the first node, the second node, the third node and the fourth node.

4. The fuel cell power supply system according to claim 3, wherein the direction-limiting elements are diodes.

5. The fuel cell power supply system according to claim 3, wherein current passing from first node to second node, from second node to third node, from first node to fourth node, and from fourth node to third node flows uniformly in forward direction; the positive end of the DC power output terminal of fuel cell unit, the positive end of the DC power output terminal of the second rechargeable battery, the positive end of the DC power output terminal of the loop switching device, and the positive end of the DC power output terminal of the first rechargeable battery being electrically connected to the first node, the second node, the third node and the fourth node respectively, the negative end of the DC power output terminal of fuel cell unit, the negative end of the DC power output terminal of first rechargeable battery, and the negative end of the DC power output terminal of second rechargeable battery being electrically connected to the negative end of the DC power output terminal of the loop switching device respectively.

6. The fuel cell power supply system according to claim 3, wherein the fuel cell unit and the rechargeable battery device are grounded with the DC power output terminal of the loop switching device.

7. The fuel cell power supply system according to claim 1, wherein the loop switching device further comprises a switch unit and a control unit, the switch unit being a logic control circuit, the control unit being a microprocessor providing logic control and controlling the switch unit in the selection of electrical contact between the fuel cell unit and any of rechargeable batteries in the rechargeable battery device and the selection of any other rechargeable battery in the rechargeable battery device for power output.

8. The fuel cell power supply system according to claim 7, wherein the plurality of rechargeable batteries in the rechargeable battery device contain a first rechargeable battery and a second rechargeable battery;
wherein the control unit controls the switch unit of the loop switching device to enable electrical contact between the fuel cell unit and the first rechargeable battery and enable electrical contact between the second rechargeable battery and the DC power output terminal of the loop switching device, or controls the switch unit of the loop switching device to enable electric contact between the fuel cell unit and the second rechargeable battery and enable electrical contact between the first rechargeable battery and the DC power output terminal of the loop switching device.

9. The fuel cell power supply system according to claim 8, wherein the loop switching device further comprises a sensor unit, the sensor unit being a power detection element and electrically connected to the first rechargeable battery and the second rechargeable battery in the rechargeable battery device respectively, and feeding the characteristics of power respectively output by the first rechargeable battery and the second rechargeable battery to the control unit, the control unit then determining the operational process of the switch unit based on such power characteristics.

10. The fuel cell power supply system according to claim 9, wherein the sensor unit detects the voltage output by the first rechargeable battery and the second rechargeable battery respectively.

11. The fuel cell power supply system according to claim 9, wherein the switch unit further comprises a first switch element and a second switch element, the first switch element and the second switch element being respectively a one-to-multi port logic control gate element, the loop switching device further comprising a first node, a second node, a third node and a fourth node;
wherein the switch unit is electrically connected to the fuel cell unit, the second rechargeable battery, the first DC power output terminal and the first rechargeable battery via the first node, the second node, the third node, and the fourth node respectively; the first switch element having an input terminal being electrically connected to the first node and two output terminals being electrically connected to the second node and the fourth node respectively, the second switch element having two input terminals being electrically connected to the second node and the fourth node respectively and an output terminal being electrically connected to the third node; the control unit controlling the first switch element to enable electrical contact between the fuel cell unit and the first rechargeable battery and controlling the second switch element to enable electrical contact between the second rechargeable battery and the electronic device, or the control unit controlling the first switch element to enable electrical contact between the fuel cell unit and the second rechargeable battery and controlling the second switch element to enable electrical contact between the first rechargeable battery and the electronic device.

12. The fuel cell power supply system according to claim 11, wherein the loop switching device further comprises a sensor unit, the sensor unit being a power detection element and electrically connected to the first rechargeable battery and the second rechargeable battery in the rechargeable battery device respectively, and feeding the characteristics of power respectively output by the first rechargeable battery and the second rechargeable battery to the control unit, the control unit then determining the operational process of the switch unit based on such power characteristics.

13. The fuel cell power supply system according to claim 12, wherein the sensor unit detects the voltage output by the first rechargeable battery and the second rechargeable battery respectively.
